(19) United States
(12) Patent Application Publication
(10) Pub. No.: US 2005/0276933 A1
(43) Pub. Date: Dec. 15, 2005

(54) Method to form a conductive structure

(76) Inventors: Ravi Prasad, Corvallis, OR (US); Jian-gang Weng, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/868,492

(22) Filed: Jun. 14, 2004

(51) Int. Cl. C08J 7/18; B05D 3/00; C09K 19/00

(52) U.S. Cl. 428/1.1; 427/299; 427/532; 428/156

(57) ABSTRACT

Embodiments of methods, apparatuses, devices, and/or systems to form a conductive structure are described.

### BACKGROUND

Electronic devices, such as integrated circuits, solar cells, and/or electronic displays, for example, may be comprised of one or more substrates, where the one or more substrates may have one or more conductive structures formed thereon. Methods of forming substrates such as these may vary, and may include subtractive processes, such as deposition, photo-lithography and/or etching, as just a few examples. Although particular processes may vary, one or more processes such as these may have particular disadvantages, for example, such processes may be time consuming and/or expensive, may not allow for the use of particular materials in one or more processes, and/or may produce inferior results.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1a is a top view of one embodiment of a device fabricated by an embodiment of a method for forming conductive structures;

FIG. 1b is a schematic diagram illustrating an embodiment of a system for forming conductive structures;

FIG. 1c is a top view of one embodiment of a device; and

FIG. 2 is flowchart illustrating one embodiment of a method for forming conductive structures.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Electronic devices, such as semiconductor devices, display devices, and/or nanotechnology devices, for example, may comprise at least one substrate. The at least one substrate may be patterned, such as to form one or more conductive structures, such as conductive lines and/or pads, for example. In one context, conductive lines may be referred to as traces, for example. As used herein, conductive, when used such as with conductive structures, generally refers to the capability to at least partially conduct electricity, and may comprise a structure that is conductive, semiconductive, or partially conductive, for example. The at least one substrate and/or the one or more conductive structures may, in at least one embodiment, comprise one or more electronic devices, such as thin films transistors (TFT), bus bars, capacitors, diodes, resistors, photovoltaic cells, insulators, conductors, optically active devices, and/or the like. Thin film devices, such as TFTs, and/or bus bars may, for example, be utilized in display devices including electroluminescent and/or liquid crystal displays (LCD). Thus, a substrate patterned to form one or more conductive structures may form a portion of an electronic device, such as a display device, for example.

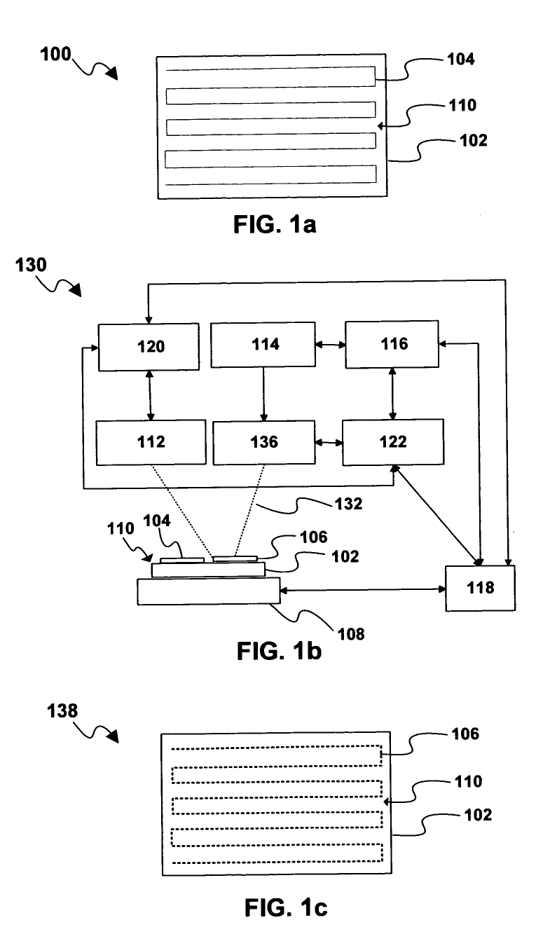

Although the claimed subject matter is not so limited, in one particular embodiment, a substrate with one or more conductive structures, such as conductive lines, formed above the substrate thereon is formed by treating at least a portion of the surface of a substrate, such as the top surface, applying a solution to at least a portion of the treated region of the top surface of the substrate, and providing electromagnetic radiation to at least a portion of the applied solution, such as by applying laser radiation to at least a portion of the applied solution, such as to cause laser radiation to impinge upon at least a portion of the applied solution, to result in at least a portion of the solution evaporating and/or fusing, such as resulting in a sintering of at least a portion of the solution, for example, resulting in the formation of conductive structures in place, for example, which may comprise selectively sintered solution, for example. Sintering, when used in this context, refers generally to a process wherein multiple portions of a material, such as a metal material, for example, may become a single mass, as a result of heating, for example. Referring now to FIG. 1a, there is illustrated an embodiment 100 of a treated substrate, illustrated as a top view. Embodiment 100 comprises substrate 102 with a top surface 110, with at least a portion of the top surface 110 treated so as to form patterned regions 104 on top surface 110. Substrate 102 may comprise a substrate of glass or plastic, as just a few examples, and may additionally comprise any combination of materials, such as polycarbonate, polyacrylate, polyimide, polyolefin, polyestersulfone, polyester, polyethylene terephthalate (PET), polyethylene naphthalate (PEN), and/or polyethersulfone (PES), but it is worthwhile to note that the claimed subject matter is not limited in this respect, and may comprise any material suitable for use as a substrate, such as any material exhibiting properties suitable for application as a substrate in an electronic device, for example. In one particular embodiment, a substrate may comprise a material and/or combination of materials that are typically lower cost as compared to other types of materials, and these particular lower cost substrates may also be particularly sensitive to high temperatures. For example, one particular material suitable for use as a substrate in at least one embodiment may substantially comprise polyester, and this particular substrate may not be suitable for use in environments in which the temperature may exceed 200 degrees Celsius, for example. Of course, as stated previously, the claimed subject matter is also not limited in this respect.

Continuing with this embodiment, at least a portion of the top surface 110 of substrate 102 may be treated, such as to form patterned regions 104. Treating, as used in this context, may comprise performing one or more processes on at least a portion of the substrate, for example. As used herein, treated or treating a surface, when used, such as with portions of a substrate, for example, generally refers to applying one or more processes to one or more portions of a substrate, such as a substrate with intervening layers, resulting in a mechanism so that material to be applied in later manufacturing adheres or substantially remains in the vicinity of the location applied, for example. In one particular embodiment treating at least a portion of substrate 102 may comprise applying one or more materials to at least a portion of one or more layers of a substrate, such as at least a portion of the surface of the substrate, and physically deforming at least a portion of the one or more applied materials, for example. In at least one embodiment, a material substantially comprising a deformable material, such as a deformable polymer resin, may be deposited on or above at least a portion of the surface of the substrate. Although numerous methods may be used to deposit one or more materials, including spin-coating and/or laminating, particular methods incorporated to perform one or more deposition processes may depend, at least in part, on the type of material and/or combination of materials deposited on the substrate, and/or the type of substrate, for example. In one embodiment, at least one of the applied materials may comprise a polymer resin, such as one or more photoresist materials, including, for example, SU8, and/or one or more other types of curable resin, such as Norland Optical Product NOA83H, as another example. Continuing with this embodiment, deforming at least a portion of the substrate, which may comprise deforming at least a portion of one or more materials deposited on the substrate, such as a polymer resin, may comprise one or more microembossing processes. Microembossing, in this context, may comprise pressing one or more types of microembossing tools on to the one or more materials deposited on or above the substrate, thereby applying pressure to the surface and at least partially deforming the surface of the one or more materials deposited on or above the substrate in the vicinity of and/or under the point of contact of the tool with the one or more materials, such as to form a pattern, for example. As will be explained in more detail later, at least a portion of the one or more applied materials may be at least partially removed in later processing, such as after one or more conductive structures are formed, for example.

Alternatively, the top surface 110 of the substrate 102 or the surface of a layer of the substrate may be chemically treated by applying a material and/or combination of materials designed to enhance wettability and/or adhesion, such as a wettability, a coupling, and/or an adhesion agent. In at least one embodiment, this material may comprise an agent capable of achieving suitable wettability, coupling, and/or adhesion properties of the surface layer of the substrate, for example. Agent, when used in this context, generally refers to a material or composition of materials capable of causing a chemical and/or physical effect, such as between the agent and one or more other materials, for example. In one particular embodiment, a material designed to enhance coupling may comprise a silane coupling agent (SCA), and may be applied in a particular pattern, such as illustrated by patterned regions 104. In at least one embodiment, a particular pattern may be based at least in part on the particular configuration of one or more conductive structures to be formed on the substrate 102, such as in a later manufactured state, for example. It is worthwhile to note, however, that numerous other methods of treating a substrate are included within the scope of the claimed subject matter, and the claimed subject matter is not limited in scope to these described embodiments.

Numerous methods for applying a material and/or combination of materials to substrate 102 are included within the scope of the claimed subject matter, but in one particular embodiment, a material such as an agent may be applied by an ejection method, such as by use of an ejection device such as an ink jet device (not shown), for example, and may be applied to selected portions of the surface of substrate 102 or of a layer of the substrate, such as in a pattern as illustrated by patterned regions 104. As used herein, an ejection device, such as an ink jet device, may comprise a mechanism capable of ejecting material such as ink, for example, and may eject material in the form of drops, for example, such as mechanically and/or electrically, and/or in response to electrical signals, for example. Additionally, as used herein, selected, when used, such as with portions of a substrate, for example, generally refers to applying a material and/or combination of materials to one or more portions of a substrate or a substrate layer, wherein the one or more portions are selected based at least in part on the particular locations of one or more portions, for example. Alternatively, a material may be applied by use of one or more spin coating, spraying, screen printing, stamping, and/or dipping operations, but, again, the claimed subject matter is not limited in this respect, and any method and/or combination of methods wherein a material or combination of materials are applied to selected portions of a substrate are included within the scope of the claimed subject matter.

Referring now to FIG. 1c, there is illustrated a substrate 102 with a top surface 110, and conductive structure region 106 formed on or over at least a portion of the top surface 110. Conductive structure region 106 may comprise one or more structures, such as conductive lines and/or pads, for example, wherein the conductive structures may be formed on at least a portion of the treated region 104 of FIG. 1a, for example. Conductive structure region 106 may, for example, be formed by use of a computer controlled conductive structure formation system, as illustrated in FIG. 1b. Illustrated in FIG. 1b is computer controlled conductive structure formation system embodiment 130; however, this is merely one example of a system in accordance with the claimed subject matter. Many other system embodiments are possible and included within the scope of the claimed subject matter. This particular embodiment, however, system 130, performs operations that may be implemented via software executing on a processor, hardware circuits, firmware, structures, and/or any combination thereof.

System 130 includes processing system 122, which may perform processing by interacting with and/or directing the actions of one or more components of formation system 130, to perform various operations, as described in more detail below. Although not illustrated in detail, processing system 122 may comprise at least one processor and one or more memory components, such as Random Access Memory (RAM), Synchronous Dynamic Random Access Memory (SDRAM), and/or Static Random Access Memory (SRAM), for example. System 130, although, again, not illustrated in detail, may further comprise: one or more hard drives; one or more removable media memory components, such as floppy diskettes, compact discs, tape drives; a display, such as a monitor, for example, and/or a user interface device, which may include a keyboard, mouse, trackball, voice-recognition device, and/or any other device that permits a user to input information and receive information.

System 130 may also comprise a support platform 108, as illustrated in FIG. 1b. Platform 108 may comprise an x-y platform, for example, and may be configured to support and/or move substrate 102 in the x-y plane, such as when undergoing one or more formation processes, for example. Furthermore, in this particular embodiment, platform 108 may be coupled to a position controller 118, which may, in at least one embodiment, be at least partially embedded in platform 108, for example. In operation, position controller 118 may receive instructions from one or more software programs stored in memory, such as memory of processing system 122 (not shown), for example, which may be executed by one or more processors of processing system 122. Position controller 118 and platform 108 may result in substrate 102 changing position in the x-y plane, for example, depending at least in part on one or more software programs being executed, for example. Alternatively, position controller may be capable of controlling the position and/or direction of laser 114 and/or ejection device 112, which may comprise an ejection device such as an ink jet device, for example, in addition to or alternatively to controlling the position of platform 108, for example. Additionally, position controller 118 may be configured to control the angle of incidence of laser beam 132, and/or the relative position of laser 114, ejection device 112, and platform 108, for example.

System 130 may further comprise a laser 114, which may be capable of generating a laser beam 132 at a particular frequency in the electromagnetic spectrum and having suitable energy to provide intense localized or “spot” heating, for example, as explained in more detail later. System 130 may also comprise a laser controller 116 coupled to laser 114, and may be configured to control the fluence, duration, and/or width of laser beam 132 when produced by laser 114. Furthermore, a beam controller 136 may be configured to perform various operations upon laser beam 132, including shaping the laser beam, changing the focal point, changing the frequency, changing the beam shape, and/or perhaps, adjusting the direction and/or position of laser beam 132 so that laser beam 132 is able to impinge upon positions and/or locations on substrate 102, although, as previously implied, depending on the embodiment, position controller 118 may, alternatively or in addition, affect the direction and/or position of laser beam 132 by affecting laser 114. Although illustrated in FIG. 1b as being projected from above top surface 110 of substrate 102, laser 114 may be projected from below the bottom surface of substrate 102 in alternative embodiments. In such alternative embodiments, laser 114 may be configured below the substrate 102, or laser beam 132 may be projected towards the bottom surface of substrate 102 or a bottom layer by use of one or more lenses and/or mirrors, as just an example. It is worthwhile to note that numerous other configurations of one or more of the components of FIG. 1b may be utilized and remain within the scope of the claimed subject matter.

Additionally, system 130 may further comprise one or more laser beam homogenizers, condensers and/or mirrors (not shown), and, additionally, laser beam 132 may be projected through a mask, a galvanometer, and/or may be projected onto a contact mask (not shown), for example. One or more of these devices may be implemented as part of beam controller 136, for example, and may be implemented in order to modulate, direct, and/or control the laser beam.

System 130 further comprises an application device, including an ejection device 112, which may be capable of applying a material and/or combination of materials to a surface, such as top surface 110 of substrate 102. For example, ejection device 112 may be configured to apply a solution to particular locations of a surface, such as in a particular pattern, for example. In one embodiment, ejection device 112 may comprise an ink jet device, although the claimed subject matter is not so limited. System 130 may further comprise an ejection device controller 120, which may be configured to control ejection device 112, such as by controlling the amount and/or location of material applied by ejection device 112 to the surface, for example. In at least one embodiment, ejection device 112 may be configured to apply a solution, such as a solution comprising nanoparticles suspended in a solvent, such as a colloidal solution. For example, a solution of gold nanoparticles suspended in toluene, such as a solution comprising approximately 30% by weight nanoparticles of gold, with diameters within the range of approximately 2-5 nm, such as available from Vacuum Metallurgical Inc. may be utilized, although this is merely an example. As used herein, nanoparticles may refer to particles of material wherein the particles have a size within the range of approximately 1 to 999 nanometers (nm), for example. Nanoparticles, as used in this particular embodiment, may comprise a material and/or combination of materials that are conductive, for example, or semi conductive, and may include gold particles, silver particles, silicon and/or germanium particles, and/or a combination thereof, as just a few examples. Additionally, one or more nanoparticles may be thermally fusible, meaning, for example, that one or more particles may fuse with one or more additional particles when supplied with sufficient energy, for example, such as the energy provided by a laser. Additionally, a nanoparticle comprising a material may have a lower melting point than the material not configured as a nanoparticle, due at least in part to the surface area to volume ratio. For example, in one particular embodiment, a nanoparticle of gold, with a diameter of 3 nm, may have a melting point of approximately 300 degrees Celsius, whereas a larger amount of gold material, such as a block of gold, may have a melting point of approximately 1000 degrees Celsius, for example. In at least one embodiment, one or more nanoparticles may be provided with sufficient energy, such as by a laser 114, that the nanoparticles reach the particle melting point or reflow temperature. The particles may thus at least partially liquefy, fuse together, and/or solidify, for example, and may result in the formation of substantially contiguous structures, such as a trace, for example. Of course, this is just an illustration of one potential mechanism by which nanoparticles may fuse, and the claimed subject matter is not so limited.

Laser 114, laser controller 116, beam controller 136, ejection device 112, ejection device controller 120, and position controller 126 may, individually and/or in combination, be controlled by suitable instructions in a software program that is stored and/or executed by processing system 122, for example. A laser suitable for use in system 130 may comprise one or more types of lasers, and may have a particular wavelength, power, and/or method of operation, and selection of one or more laser characteristics may depend on a variety of factors, such as absorptivity of one or more nanoparticles applied by ejection device 112, and/or one or more other factors, for example. Laser 114 may comprise, for example, a stepped or pulsed laser, and/or may be capable of producing a continuous beam. In one embodiment, the laser may comprise a laser with an argon source, capable of operating in the vicinity of a wavelength of approximately 488 nm, with a fluence of approximately 0.1 mW/μm², and/or in a continuous mode, as just an example, but, again, the claimed subject matter is not so limited. As an example, one more embodiment may comprise a laser capable of producing visible and/or non-visible electromagnetic radiation. An ejection device suitable for use in system 130 may comprise any device capable of ejecting material, such as a solution, resulting in the application of a solution to substrate top surface 110, for example. Ejection device 112 may comprise an ink jet device, for example, and may further comprise one or more ink jet heads. Additionally, ejection device 112 may operate by use of one or more ejection schemes, including piezo ejection, thermal ejection, and/or flex tensioned ejection, for example, but, again, the claimed subject matter is not so limited.

In operation, a substrate, such as substrate 102, with treated regions 104 may be positioned on platform 108. Ejection device 112 may perform one or more ejection operations, resulting in material being applied to the top surface 110 of substrate 102, for example. In at least one embodiment, platform controller 118 may result in platform 108 moving to one or more locations, and ejection device controller 120 may result in the ejection device ejecting material to one or more locations of substrate top surface 110, resulting in material being applied to one or more locations, such as the treated regions 104, for example. In this embodiment, for example, a solution of nanoparticles suspended in a solvent may be applied to substrate top surface 110, such as to one or more treated regions 104, wherein the treated regions are patterned with one or more wettability and/or adhesion agents, which may result in at least a portion of the solution to adhere to substrate top surface 110, for example. In this embodiment, subsequent to a portion of solution being applied to treated regions 104, the laser controller and/or beam controller may receive instructions resulting in laser 114 producing laser radiation in the form of a laser beam applied to a location of substrate top surface 110, such as to treated regions 104 in which solution has been applied by ejection device 112, for example. This may result, for example, in a selected portion of the solution being evaporated, fused and/or sintered, such as a portion of the solvent being evaporated and/or at least a portion of the nanoparticles being fused, such as if, for example, the solution applied comprises nanoparticles suspended in a solvent, for example. In this embodiment, application of the laser radiation may result in a sintering process, so that the nanoparticles are selectively sintered, at least in part, and/or at least partially fused, resulting in the formation of one or more structures, such as conductive structures, in conductive structure region 106, for example. Conductive structures, such as illustrated in FIG. 1c, for example, are explained in more detail below.

In operation, in one embodiment, laser 114 may produce a continuous wave beam, or may be pulsed or Q-switched, for example, and the manner of operating laser 114 may depend on a variety factors, such as at least in part the material applied by ejection device 112, and/or the type of laser, for example. In one embodiment, laser 114 may be operated in a pulsed manner, in which the laser beam may be pulsed sequentially by being turned on relatively briefly, e.g. for 20 nanoseconds (ns), and then turned off, while the beam is stepped or scanned to other regions of substrate 102, such as by moving the substrate with respect to the laser by x-y table 108, for example. Alternatively, the laser may operate to apply multiple pulses to a single region or location in another embodiment, for example.

After at least a portion of the solution and/or nanoparticles absorb the laser radiation, or laser flux, one or more of the nanoparticles may be selectively sintered, at least in part, and/or may fuse, at least in part, forming one or more structures 106. For example, if the laser irradiates a portion of the solution, at least a portion of the solution may reflow and/or solidify, such as one or more nanoparticles of the solution, and/or at least a portion of the solvent may evaporate, for example. The amount of energy supplied by the laser may determine at least in part the affect on the area and/or particles that absorb the energy. The energy may be dependent at least in part on a variety factors including, at least in part, the wavelength of the laser, the pulse frequency, the fluence of the beam, the focal point of the beam, and/or the method of operation of the beam, as just a few examples. Additionally, the amount of energy utilized to form one or more conductive structures may depend at least in part on factors including the type and/or size of the nanoparticles applied to the substrate treated regions, and/or the material(s) used to form substrate 102. For example, nanoparticles of differing materials, such as gold and/or silver, may have differing melting points, and, additionally, nanoparticles with a larger surface area to volume ratio may have lower melting temperatures as compared to nanoparticles of the material with a smaller surface are to volume ratio, as just an example. Additionally, substrate materials may at least partially affect the choice of the amount of laser energy to apply, and/or may at least partially or potentially set a limit to the laser energy that may be applied before affecting the substrate at least in part, such as by melting. For example, a substrate of polyester may be more responsive to thermal energy, at least in part, than a substrate of glass. Thus, the particular material may at least in part affect the upper limit on laser energy that may be applied to a portion of the substrate before resulting in physical affects, such as melting, for example. Therefore, selection of nanoparticle sizes and/or materials may depend at least in part on the selection of material(s) used to form a substrate, and conversely, selection of a substrate may affect at least in part the selection of nanoparticle materials and/or sizes, for example.

Additionally, the elapsed time between the application of a solution by ejection device 112 and the application of laser energy may depend, at least in part, on the solution employed. For example, a solution comprising nanoparticles suspended in a solvent may be at least partially volatile, meaning, in this context, for example, that the solvent may evaporate when exposed to air. In this embodiment, the laser energy may be applied prior to the evaporation of the solvent, or at some time substantially coincident with the evaporation of the solvent, for example, so that the nanoparticles are still at least partially suspended in the solvent when laser energy is applied, for example. Fusing of at least a portion of the nanoparticles of a solution, such as those applied to treated regions 104, may therefore result in the formation of a substrate 102 with one or more conductive structures, such as traces formed thereon, as illustrated by FIG. 1c, for example. In at least one embodiment, device 138 of FIG. 1c may comprise a substrate 102 with multiple conductive traces 106 formed thereon, and may comprise a unit or subunit suitable for use in an electronic device, such as an LCD, for example, and/or may comprise one or more electrical components, such as TFTs, when assembled in a later manufactured state, for example.

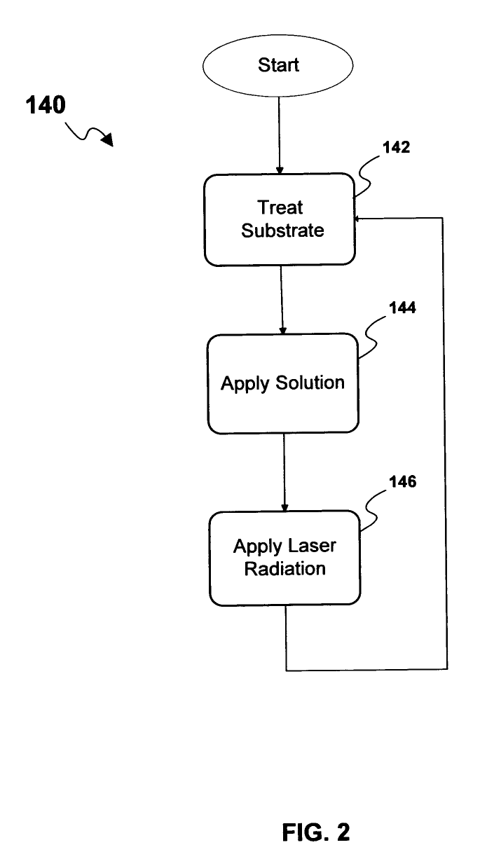

Referring now to FIG. 2, one embodiment of a technique for forming conductive structures is illustrated by a flowchart, although, of course, the claimed subject matter is not limited in scope in this respect. Thus, such an embodiment may be employed to at least partially form one or more conductive structures, as described below. The flowchart illustrated in FIG. 2 may be used to form a device at least in part, such as device 138 of FIG. 1c, for example, although the claimed subject matter is not limited in this respect. The order in which the blocks are presented may not limit the claimed subject matter to any particular order. Likewise, intervening additional operations and/or processes not shown by intervening blocks may be employed without departing from the scope of the claimed subject matter.

Flowchart 140 depicted in FIG. 2 may, in alternative embodiments, be implemented in software, hardware and/or firmware, such as by system 130 of FIG. 1b, for example, and may comprise discrete and/or continual operations. In this embodiment, at block 142, a substrate surface is at least partially treated, which may comprise applying a pattern of material, such as a wettability and/or adhesion agent, for example, and/or may comprise applying one or more materials and/or physically deforming portions of the applied one or more materials, for example. At block 144, one or more solutions may be selectively applied to at least a portion of the treated regions of the substrate, such as by an ejection device including an ink jet device, for example. At block 146, laser radiation may be applied to the selectively applied one or more solutions, such as immediately subsequent to the application of a portion of one or more solutions to a patterned region of a substrate, and/or after a duration, such as approximately 10 milliseconds, for example. In at least one embodiment, one or more of the aforementioned operations may be repeated, such as to form a substrate with conductive structures, such as substrate 138 of FIG. 1c, for example.

Treating a substrate may comprise applying a material, such as an agent, to portions of a substrate, such as in a particular pattern, to the surface of a substrate. However, as stated previously, treating, for example, generally refers to applying one or more processes to one or more portions of a substrate, resulting in a mechanism so that material to be applied in later manufacturing adheres or substantially remains in the vicinity of the location applied, for example. In one embodiment, treating may comprise selectively applying a material to portions of a substrate, such as a pattern of to be formed conductive structures, for example. In particular, in one embodiment, the substrate may comprise a non-conductive substrate, such as glass, plastic, and/or a combination of materials, such as polyester, for example. Likewise, a material that may be applied may comprise a liquid and/or semi-liquid, such as a wettability and/or adhesion agent, and may be applied by one or more deposition methods, including, ejecting, spraying, dipping, screen printing, stamping, spreading and/or spin coating, for example. The material may be applied at locations on the substrate, such as in one or more patterns, and may be applied based at least in part on a pattern of conductive structures to be formed on the substrate, such as during a later manufacturing operation, for example. In at least one example embodiment, the material may comprise a silane coupling agent, and may be selectively applied by an ejection process by use of an ink jet device. The material may be applied in a pattern, such as to one or more locations of the substrate, for example, as described previously. Additionally, treating a substrate may comprise applying one or more materials, such as one or more deformable materials, to at least a portion of the surface of a substrate, and microembossing at least a portion of the one or more materials, such as in a pattern, for example. Microembossing, in this context, may comprise pressing or applying one or more types of microembossing tools to the one or more applied materials, thereby applying pressure to the surface and at least partially deforming the one or more applied materials, such as to form a pattern, for example, as previously described. Numerous methods of treating a substrate are included within the scope of the claimed subject matter. In general, any method of treating a surface resulting in a resulting in a mechanism so that material adheres or substantially remains in the vicinity of the location applied is included within the scope of the claimed subject matter.

Continuing with this embodiment, at block 144, one or more solutions may be applied to at least a portion of the treated regions of the substrate. Again, numerous methods exist or may be developed later for applying a solution, including ejecting, spraying, dipping, spreading and/or spin coating, for example. The methods for applying a solution may depend at least in part on the solution applied, for example. A solution may be applied at locations on the substrate, such as to one or more treated regions where a material was applied to the substrate at block 142, for example, and may be applied based at least in part on a pattern of conductive structures to be formed in place on the substrate during a later manufacturing operation, for example. Alternatively, a substantial portion of the substrate may be coated with a solution, such as by use of spin coating, for example. In at least one example embodiment, a solution may comprise a solution of nanoparticles suspended in a solvent, and/or may be applied by an ejection process by use of an ejection device. The material may be applied in a pattern, such as to one or more locations of the substrate, for example, as described previously. In one embodiment, a suspension of nanoparticles of gold, comprising 30% of the suspension by weight, having a diameter within the range of approximately 2-5 nm, and/or suspended in toluene, may be applied by use of an ejection device, and/or may be applied to at least a portion of the treated regions of a substrate, formed at block 142, for example.

In this embodiment, moving to block 146, laser radiation may be applied to at least a portion of the substrate, such as to one or more regions where one or more solutions were applied at block 144, for example. Although methods for applying laser radiation may vary, in this embodiment, a system, such as system 130 of FIG. 1b, may be utilized to apply laser radiation. In this embodiment, a patterned substrate may be provided to a system, such as system 130, and the laser of system 130, which may comprise a laser capable of producing laser radiation, such as a laser with an Argon source, capable of operating in the vicinity of a wavelength of approximately 488 nm, with a fluence of approximately 0.1 mW/μm², and/or capable of operating in a continuous mode, may be operated to provide laser radiation to one or more portions of the substrate. For example, in the example embodiment noted previously, a solution of nanoparticles suspended in a solvent may be applied with laser radiation. This may result in at least a portion of the solvent evaporating, and/or at least a portion of the nanoparticles fusing, potentially resulting in a portion of the material sintering, resulting in selectively sintered nanoparticles. This may result in the formation of one or more structures in place, which may comprise conductive structures, depending at least in part on the type and/or size of nanoparticles, and/or the substrate material, for example. The laser radiation may be applied at some time subsequent to the application of a material at block 144, such as immediately subsequent or after a duration following application of a solution, such as 10 milliseconds, for example. The time duration between the application of a material at block 144 and application of laser radiation at block 146 may depend at least in part on a variety of factors, such as the material applied, and/or the evaporation rate of the material, for example, as described previously. In this manner, after application of laser radiation, a device, such as device 138 of FIG. 1c, may be formed, for example. Alternatively, if one or more materials are applied to the substrate, such as in block 142, one or more removal processes may be performed, such as after application of laser radiation at block 146, for example. The particular type of removal processes may depend at least in part on the type of material and/or combination of materials applied at block 142, but in one particular embodiment, where a deformable polymer resin is applied to at least a portion of the surface of a substrate, one or more solvents may be applied to result in at least a portion of the polymer resin being removed, resulting in the at least partial removal of the applied material, and/or the formation of a device, such as device 138 of FIG. 1c, for example.

It is, of course, now appreciated, based at least in part on the foregoing disclosure, that software may be produced capable of performing a variety of operations, including one or more of the foregoing operations. It will, of course, also be understood that, although particular embodiments have just been described, the claimed subject matter is not limited in scope to a particular embodiment or implementation. For example, one embodiment may be in hardware, such as implemented to operate on a device or combination of devices as previously described, for example, whereas another embodiment may be in software. Likewise, an embodiment may be implemented in firmware, or as any combination of hardware, software, and/or firmware, for example. Additionally, all or a portion of one embodiment may be implemented to operate at least partially in one device, such as a laser device, and/or at least partially in a computing device, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, and/or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. A method, comprising:
treating at least a portion of a substrate;
applying one or more solutions to at least a portion of the treated portion of the substrate; and
providing electromagnetic radiation impinging upon said one or more solutions to form conductive structures in place.

2. The method of claim 1, wherein said electromagnetic radiation comprises radiation produced by a laser.

3. The method of claim 1, wherein said substrate comprises at least one of: glass, polycarbonate, polyacrylate, polyimide, polyolefin, polyestersulfone, polyester, polyethylene terephthalate (PET) polyethylene naphthalate (PEN), or polyethersulfone (PES).

4. The method of claim 1, wherein said treating further comprises:
applying at least one material to at least a portion of said substrate.

5. The method of claim 4, wherein at least one of said at least one materials comprises a silane coupling agent (SCA).

6. The method of claim 4, wherein at least one of said at least one materials comprises a wettability agent.

7. The method of claim 4, wherein at least one of said at least one materials comprises an adhesion agent.

8. The method of claim 4, wherein at least one of said at least one material comprises a deformable material.

9. The method of claim 8, wherein said deformable material substantially comprises polymer resin.

10. The method of claim 8, wherein said treating further comprises microembossing at least a portion of said at least one material.

11. The method of claim 8, wherein said microembossing further comprises deforming at least a portion of said at least one material by use of an embossing tool.

12. The method of claim 1, wherein said applying further comprises:
selectively applying said one or more solutions to said substrate, wherein said selectively applying is substantially performed by an ejection device.

13. The method of claim 12, wherein said ejection device comprises an ink jet device.

14. The method of claim 1, wherein at least one of said one or more solutions comprises a solution of conductive particles at least partially suspended in a solvent.

15. The method of claim 14, wherein said solution comprises nanoparticles of gold and/or silver, having diameters substantially within the range of 2 to 5 nanometers, and suspended in a solvent of toluene.

16. The method of claim 1, wherein at least one of said one or more solutions comprises a solution of conductive nanoparticles.

17. A method, comprising:
a step for treating at least a portion of at least one surface of a substrate;
a step for applying one or more solutions to at least a portion of the treated portion of the substrate; and
a step for providing electromagnetic radiation impinging upon said one or more solutions to form conductive structures in place.

18. The method of claim 17, and further comprising a step for removing at least a portion of said one or more applied solutions.

19. The method of claim 17, wherein said substrate comprises at least one of: plastic or glass.

20. The method of claim 17, wherein said step for treating further comprises applying a silane coupling agent (SCA) to at least a portion of said at least one surface of a substrate.

21. The method of claim 17, wherein said step for treating further comprises applying a deformable material to at least a portion of said at least one surface of a substrate.

22. The method of claim 21, wherein said deformable material substantially comprises polymer resin.

23. The method of claim 17, wherein said step for treating further comprises microembossing at least a portion of said at least one material by use of an embossing tool.

24. The method of claim 17, wherein said step for applying further comprises:
a step for selectively applying said one or more solutions to said substrate, wherein said step for selectively applying is substantially performed by an ejection device.

25. The method of claim 17, wherein at least one of said one or more solutions comprises a solution of conductive nanoparticles at least partially suspended in a solvent.

26. The method of claim 17, wherein said electromagnetic radiation comprises radiation produced by a laser.

27. The method of claim 21, and further comprising:
a step for removing at least a portion of said material.

28. A device, formed substantially by a process comprising:
selectively treating at least one surface of a substrate;
applying one or more solutions to at least a portion of the treated surface;
providing electromagnetic radiation impinging upon said one or more solutions to form conductive structures in place.

29. The device of claim 28, wherein said selectively treating further comprises applying an adhesion promoter to at least a portion of said at least one surface of a substrate.

30. The device of claim 28, wherein said selectively treating further comprises applying one or more materials to at least a portion of at least one surface of a substrate.

31. The device of claim 30, wherein said selectively treating further comprises embossing at least a portion of said one or more materials.

32. The device of claim 28, wherein said applying one or more solutions further comprises applying one or more solutions by use of an ejection device.

33. The device of claim 32, wherein said ejection device comprises an ink jet device.

34. The device of claim 32, wherein at least one of said one or more solutions comprises a nanoparticle solution.

35. The device of claim 28, wherein said radiation is provided by use of an Argon laser.

36. The device of claim 28, wherein said device further comprises a liquid crystal device.

37. An apparatus, comprising:
an ejection device, said ejection device being configured to, in operation, selectively apply a solution to at least a portion of a substrate; and
a laser, said laser being configured to, in operation, apply laser radiation to selected portions of a substrate, such as to form conductive structures in place.

38. The apparatus of claim 37, wherein said substrate comprises at least one of: glass, polycarbonate, polyacrylate, polyimide, polyolefin, polyestersulfone, polyester, polyethylene terephthalate (PET) polyethylene naphthalate (PEN), or polyethersulfone (PES)

39. The apparatus of claim 37, wherein said substrate is at least partially treated with an adhesion promoter.

40. The apparatus of claim 39, wherein said adhesion promoter comprises a silane coupling agent (SCA).

41. The apparatus of claim 37, wherein said substrate is at least partially coated with a deformable material.

42. The apparatus of claim 41, wherein said deformable material substantially comprises a polymer resin.

43. The apparatus of claim 41, wherein said deformable material is at least partially microembossed.

44. The apparatus of claim 37, wherein said ejection device comprises an ink jet device.

45. The apparatus of claim 37, wherein said solution comprises a nanoparticle solution.

46. The apparatus of claim 45, wherein said nanoparticle solution further comprises nanoparticles of gold, having diameters substantially within the range of 2 to 5 nanometers, and suspended in a solvent of toluene.

47. An apparatus, comprising:
a substrate having a top surface;
one or more conductive structures formed on the substrate top surface, wherein at least a portion of said one or more conductive structures comprise selectively sintered nanoparticles.

48. The apparatus of claim 47, wherein said substrate comprises at least one of: glass, polycarbonate, polyacrylate, polyimide, polyolefin, polyestersulfone, polyester, polyethylene terephthalate (PET) polyethylene naphthalate (PEN), or polyethersulfone (PES)

49. The apparatus of claim 47, wherein said substrate top surface is at least partially coated with a deformable material.

50. The apparatus of claim 49, wherein said deformable material substantially comprises a polymer resin.

51. The apparatus of claim 49, wherein said deformable material is at least partially microembossed.

52. A system, comprising:
a computing device,
a display device coupled to the computing device, wherein the display device further comprises:
a substrate having a top surface;
one or more conductive structures formed on the substrate top surface, wherein at least a portion of said one or more conductive structures comprise selectively sintered nanoparticles.

53. The system of claim 52, wherein said display device further comprises a liquid crystal display.

54. The system of claim 52, wherein at least a portion of said one or more conductive structures comprise thin film transistors.

55. The system of claim 52, wherein said substrate comprises at least one of: glass, polycarbonate, polyacrylate, polyimide, polyolefin, polyestersulfone, polyester, polyethylene terephthalate (PET) polyethylene naphthalate (PEN), or polyethersulfone (PES)

56. The system of claim 52, wherein said substrate top surface is at least partially coated with a polymer resin, wherein at least a portion of the polymer resin is microembossed.
